(19) United States
(12) Patent Application Publication
(10) Pub. No.: US 2007/0096691 A1
(43) Pub. Date: May 3, 2007

(54) Wireless battery charger detection and notification

(76) Inventors: Bruce Duncan, Bracknell (GB); David A. Bell, London (GB)

Correspondence Address: PHILIPS INTELLECTUAL PROPERTY & STANDARDS, P.O. BOX 3001, BRIARCLIFF MANOR, NY, 10510, US

(21) Appl. No.: 10/560,002

(22) PCT Filed: Jun. 4, 2004
(86) PCT No.: PCT/IB04/01907

§ 371 Date: Dec. 8, 2005

(30) Foreign Application Priority Data
Jun. 12, 2003 (GB) 0313520.9

(51) Int. Cl. H02J 7/00

(52) U.S. Cl. 320/114

(57) ABSTRACT

The availability of a charging facility for a portable electronic device is detected by the portable electronic device by establishing a short range wireless communication link between a battery charger and the portable device, and transferring compatibility data over the wireless communication link from the charger to the portable electronic device to determine a compatibility between the battery charger and the portable electronic device. The portable electronic device (such as a mobile phone or PDA) comprises: means for receiving a rechargeable battery; means for receiving compatibility data, over a wireless communication link, from a remotely located battery charger, and means for using said compatibility data to detect the presence of a battery charger compatible with the portable electronic device. The battery charger comprises: charging means for providing power for recharging a battery; and means for transmitting compatibility data, over a wireless communication link, to a remotely located portable electronic device. An alert device is incorporated to notify the user of the existence of the compatible battery charger.

The present invention relates to battery charging systems for portable electronic devices.

A large number of portable electronic devices require frequent battery charging. Such devices include mobile telephones, personal digital assistants, digital cameras, notebook computer systems, and the like. Users of such devices are therefore heavily reliant on the availability of suitable battery charging facilities and also on remembering to charge the device at times when such suitable charging facilities are available.

A problem with the availability of battery charging facilities is that there is little standardisation in the charging requirements for many portable electronic devices. Different batteries require different charging parameters depending upon a number of factors such as battery chemistry and capacity. Different manufacturer's devices often have different contacts or plug/socket layouts.

Unless users of portable devices routinely carry appropriate charging equipment with them (which somewhat detracts from the portability of such devices), they are reliant on charging equipment being available at home, at the office, in vehicles, at hotels and business centres and the like. However, even where charging facilities are available, it will not always be obvious that this is so, nor whether the facilities are fully compatible with the user's device.

Some prior art documents have suggested multi-purpose chargers capable of determining battery charging parameters from the battery packs themselves. For example, U.S. Pat. No. 5,596,567 describes a battery charging system in which a battery pack is provided with a memory for storing data specific to the battery and/or battery type, with a wireless communication module for a battery charger to read this information and thus determine how the battery should be charged. The wireless communication system is therefore very short range to avoid confusion with other battery packs which may be proximal to the charger.

U.S. Pat. No. 5,963,012 describes a battery charging system with a means for determining both static and dynamic charging parameters of a battery prior to and during a battery charging operation. The communication between the charger and the battery is provided by wireless communication link and includes static parameters such as battery capacity and chemistry type, and dynamic parameters such as temperature, pressure and voltage. The apparatus is particularly suited for contactless inductive battery charging systems.

A disadvantage of both of these systems is that there is still no convenient way for a user of a portable electronic device to be automatically made aware of the existence of a charger that is compatible with the electronic device in the vicinity.

JP 05 344 056 proposes a portable radio telephone set that cooperates with a local wireless ‘home base’ station, as well as with a cellular telephone network. When the telephone set is in communication with the ‘home base’ station, but is not coupled to a charger, a timer is triggered to alert the user, after a predetermined period of time, that the portable set should be recharged. This avoids the problem that the set is taken away from the vicinity of its home base station with a low battery capacity.

It is an object of the invention to provide a method and apparatus for detecting the presence of a compatible battery charger for a portable electronic device.

It is a further object of the invention to provide a means for alerting a user to the existence of a compatible battery charger for a portable electronic device being carried by the user.

According to one aspect, the present invention provides a portable electronic device comprising:

means for receiving a rechargeable battery;

means for receiving compatibility data, over a wireless communication link, from a remotely located battery charger; and

means for using said compatibility data to detect the presence of a battery charger compatible with the portable electronic device.

According to another aspect, the present invention provides a battery charger for a portable electronic device comprising:

charging means for providing power for recharging a battery; and

means for transmitting compatibility data, over a wireless communication link, to a remotely located portable electronic device.

According to another aspect, the present invention provides a method of automatically establishing the availability of a charging facility for a portable electronic device, comprising the steps of:

establishing a short range wireless communication link between a battery charger and a portable electronic device; and

transferring compatibility data, over the wireless communication link, from the charger to the portable electronic device to determine compatibility between the battery charger and the portable electronic device.

Further features and aspects of the present invention are defined in the attached claims to which the reader is now directed and the disclosure of which is incorporated herein by reference.

Embodiments of the present invention will now be described by way of example and with reference to the accompanying drawings in which:

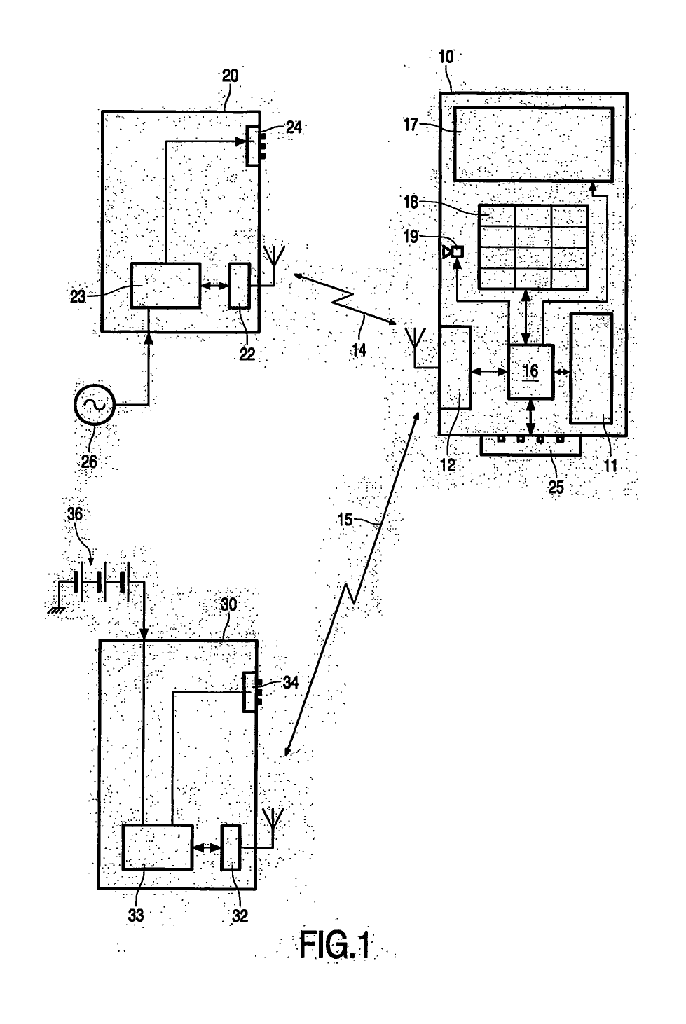

FIG. 1 is a schematic block diagram showing components of a battery charger and mobile telephone and communication link therebetween for realising automatic charger detection; and

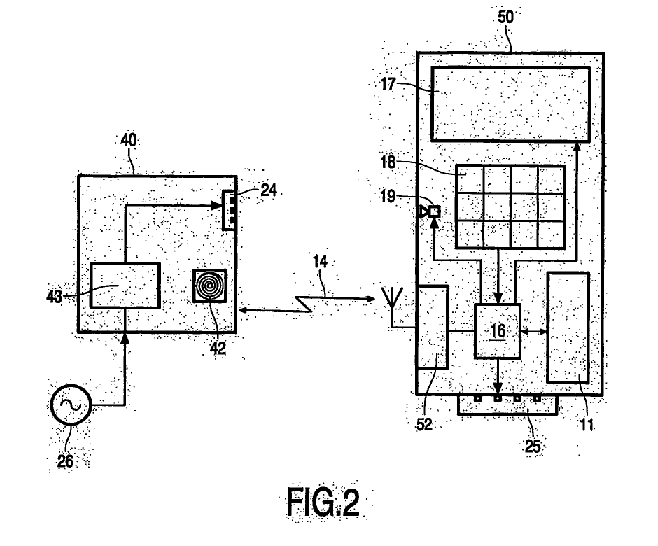

FIG. 2 is a schematic block diagram showing components of an alternative arrangement of battery charger and mobile telephone for realising automatic charger detection.

With the widespread use of portable electronic devices, charging facilities are also becoming widespread and are now available in many homes, offices, vehicles, hotels, business centres and other public places. These charging facilities tend to be unobtrusive, and the user of a portable electronic device may have the possibility of recharging the batteries of the device, but not be aware of it. In addition, even where the availability of battery charging facilities is indicated to users, such is the number of different charging systems and different requirements of portable electronic devices, that there is no guarantee that the user's device is compatible with the local charging facilities available. Even where the user is located in their own home, or another location where they are already aware that charging facilities exist, they may not remember that there is an opportunity to recharge their portable electronic device.

As shown in FIG. 1, a portable electronic device 10 is provided with the capability to communicate with one or more battery chargers 20, 30 with which it is compatible.

The portable electronic device 10 may be any electronic device that makes use of a rechargeable battery 11. The system to be described herein is, however, particularly suited to mobile telephones, personal digital assistants, digital cameras, notebook computers, personal audio devices such as MP3 players, CD players, MID players and the like, and personal video devices, such as DVD players and the like.

Portable electronic device 10 is provided with a short range wireless communication module 12 for receiving data from a battery charger 20, 30 located in the vicinity. In a preferred configuration, the short range wireless communication module makes use of the Bluetooth communication protocol. However, it will be understood that other short range wireless communication modules can be used, such as those using the IEEE 802.11 standard, or a suitable infra-red based system. Infra red systems are generally less desirable, in that a general line of sight between transmitter and receiver is required. This may be less effective, or not effective, when the portable device is in a case, pocket or the like. A Bluetooth module configuration is presently preferred due to its compatibility with, and incorporation within, many existing devices such as mobile telephones, notebook computers and the like.

The portable electronic device also preferably includes a control circuit 16, a display module 17, a keypad 18, an audio output device 19, and a battery charging connector 25. The display module, 17, keypad 18, audio output device 19 and battery charging connector 25 may be shared with the conventional such features as found on the device, or may be provided separately for the purposes as defined herein.

The battery charger 20 or 30 also includes a supply module 23, 33 that provides charging power to an outlet connector 24 or 34 respectively, and also to the short range wireless device 22, 32.

For charging, the outlet connector 24, 34 is connected to the battery charging connector 25 of the portable electronic device 10 using an appropriate lead (not shown). Alternatively, the outlet connector 24, 34 may comprise a flying lead with an appropriate plug or socket on one end adapted for mating with the charging connector 25.

In another arrangement, the outlet connector 24, 34 and the charging connector 25 may be adapted for wireless communication, eg. by inductive charging link. This is particularly desirable for waterproof portable electronic devices where external connections or contacts are not desirable.

In use, the short range wireless communications module 12 uses a wireless channel 14, 15 to communicate with a corresponding module 22, 32 on any battery charger 20, 30 that is within range. Typically the range of such devices is of the order of a few metres, or at most 10-20 metres. Where the communications protocol allows an assessment of signal strength or some other determination of relative distance between the transmitter/receiver, it may be possible to fix a predetermined distance limit over which the two devices will communicate. In one preferred configuration, the range would be predetermined to operate within the same room of a building, for example.

The portable electronic device 10, upon establishing a communications link 14, 15 with at least one such battery charger 20, 30, obtains compatibility data from that charger to establish whether the charger is of a type suitable for recharging the battery 11 of the portable electronic device 10. This compatibility data may take a number of possible forms.

In one example, each battery charger 20, 30 may be provided with a predetermined device serial number, or device type code number. The portable electronic device 10 is pre-programmed, in a control unit 16, with a list of charger serial numbers or device type code numbers with which it is compatible. Upon receiving the appropriate number from the charger, the portable electronic device checks its pre-programmed list to establish whether the charger is compatible. If it is compatible, the control circuit 16 of the portable electronic device 10 preferably signals the detection of a compatible charger by way of an audio signal using audio output device 19, or by way of a visual display on display module 17. On mobile telephones, a vibration alert is also commonly included to replace or supplement audio ring tones, and this alert device could also be triggered by the control circuit 16.

In another example, the battery charger 20, 30 and the portable electronic device 10 may exchange data relating to the charging requirements of the portable device. For example, the portable device may transmit its required battery charging parameters, such as battery capacity, battery chemistry, charging voltage and/or current, charging pattern, interconnection configuration, manufacturer, current battery charge and the like. The charger can then verify whether it is able to service that requirement, and if so, transmit compatibility data in the form of a confirmation of compatibility to the portable electronic device.

In another example, the roles could be reversed, in that the battery charger 20 may transmit charging parameters that it is capable of delivering. The portable electronic device 10 then checks to see whether these parameters are compatible with its own requirements. In a more sophisticated arrangement, it may be possible for the two devices 10, 20 to ‘negotiate’ charging requirements. In other words, it may be possible for the charger 20 to supply data relating to a range of possible charging parameters available, and the portable device 10 to make a selection therefrom.

In preferred arrangements, it is recognised that the charger 20, 30 has access to a mains power supply 26 or regenerating (eg. automotive) power supply 36 and therefore is not significantly constrained in power usage. Therefore, it is preferable that the heaviest transmission burden should fall on the charger 20, 30 rather than the portable device 10.

In the preferred arrangement, the charger 20, 30 periodically transmits to any portable electronic devices 10 in the vicinity and attempts to open a communication channel therewith. Such techniques are, for example, specified in the Bluetooth protocol. In the event that a portable electronic device 10 is found, the charger 20, 30 then transmits compatibility data to the portable device.

In another arrangement, the charger 20, 30 may include a means for communicating an expected availability time. Thus, if the charger is temporarily unavailable (possibly due to use by another portable device at the time), it may transmit an estimated charge completion time when it will be available for use by the next portable device. This charge completion time (or expected ‘available’ time) may be displayed on the display module 17 of the receiving portable device 10.

In another arrangement, the provision of battery charging services may be provided at cost to the user of the portable device. In this case, the charger 20, 30 may be adapted to transmit, to the portable electronic device 10, tariff information. This can also be displayed on the display module 17 of the portable electronic device 10. The tariff information may be customised according to the detected type of device or battery to allow for differential charging according to portable device type.

In another arrangement, to avoid ‘nuisance’ notifications, the charger 20, 30 and/or portable electronic device 10 may be configured not alert the user to the presence of the compatible charger until after it has been established that there is a likelihood that the portable device will remain in the vicinity of the charger for an extended period of time. This function may be realised by delaying any alert to the user until the portable electronic device has been within range of the charger for an extended period of time or has been repeatedly detected within a predetermined time window. Thus a person merely walking past the charger will not trigger an alert whereas a person sitting in the location (eg. vehicle, railway carriage, hotel room, airport departure lounge etc) will be alerted after a few minutes.

Thus, in a general aspect, the portable electronic device may include an alert device that is adapted to alert the user of the existence of a detected battery charger only upon the existence of further predetermined conditions, such as duration of detection of the charger. This may be a function of the detected location, eg. whether it is in a public or private place, vehicle or otherwise.

In another arrangement, the portable electronic device 10 may be adapted to display the location of the charger 20, 30. This may be by way of a text message provided by the charger. Alternatively, where the short range communication link enables range and/or direction finding, the relative location of the charger may be deduced by the portable device.

In other arrangements, the portable electronic device 10 may be provided with a user option for suppressing use of the charger detection system when it is not wanted. This suppression might also be triggered automatically when the battery charge status is above a certain threshold. Similarly, the charger 20, 30 may be provided with a user option for suppressing the charger detection system, for example when the operator of the charger does not want to make the service available.

The arrangement described in connection with FIG. 1 relates to a system in which both the charger 20, 30 and the portable device 10 have an active transmitter/receiver module 12, 22, 32. As now described in connection with FIG. 2, the battery charger 40 could alternatively be provided with a passive transmitter/receiver 42. The expression ‘passive’ is intended to indicate that the transmitter/receiver transmits only in response to a signal transmitted externally thereto.

For example, the passive transmitter/receiver may be an RFID tag 42 which transmits compatibility data in response to an interrogation signal from the portable electronic device 50. In this configuration, the portable device 50 comprises an active transmitter/receiver 52 capable of reading data from the tag 42 remotely. This configuration allows the passive tag 42 to be added to the charger without integration with its electronic systems (ie. power supply 43), such as by simple adhesion of an RFID tag to an external surface thereof. However, it does have the drawback that the portable electronic device 10 bears the burden of energy consumption in looking for available chargers.

Other embodiments are intentionally within the scope of the appended claims.

1. A portable electronic device (10, 50) comprising:
means for receiving a rechargeable battery (11);
means (12, 16) for receiving compatibility data, over a wireless communication link (14, 15), from a remotely located battery charger (20, 30); and
means for using said compatibility data to detect the presence of a battery charger (20, 30) compatible with the portable electronic device.

2. The device of claim 1 in which the means (12, 16) for receiving compatibility data comprises a short range wireless device (12).

3. The device of claim 2 in which the short range wireless device (12) comprises one of a Bluetooth module, an IEEE 802.11 module, or an infra red module, adapted to communicate with an active wireless module (22) in the charger (20).

4. The device of claim 2 in which the means (52, 16) for receiving compatibility data comprises an RFID transceiver, adapted to communicate with a passive wireless device in the charger (42).

5. The device of claim 1 further including an alert device (16, 17, 19) for alerting the user of the existence of a detected battery charger.

6. The device of claim 5 in which the alert device (16, 19) is adapted to generate an audible output.

7. The device of claim 5 in which the alert device (16, 17) is adapted to generate a visual output.

8. The device of claim 5 in which the alert device is adapted to generate a vibration output.

9. The device of claim 1 further including a rechargeable battery (11).

10. The device of claim 9 in which the alert device (16) is inhibited when the charge level of the battery (11) of the portable electronic device is greater than a predetermined amount.

11. The device of claim 9 in which the means (12, 16) for receiving compatibility data is inhibited when the charge level of the battery (11) of the portable electronic device is greater than a predetermined amount.

12. The device of claim 1 in which the means (12, 16) for receiving compatibility data operates intermittently.

13. The device of claim 1 in which the means (12, 16) for receiving compatibility data operates only in response to a transmission from a compatible remotely located battery charger (20, 30).

14. The device of claim 1 in which the compatibility data includes a predetermined code sequence indicating compatibility between the charger and the portable electronic device.

15. The device of claim 1 in which the compatibility data includes one or more charge parameter including: battery capacity, battery chemistry, charging voltage and/or current, charging pattern, interconnection configuration, manufacturer, current status, charge time remaining to availability, charge tariff, charger location.

16. The device of claim 1 in which the portable electronic device (10, 50) is any one of a mobile telephone, a personal digital assistant, a digital camera, a notebook computer system, a personal audio device, a personal video device or a hybrid of any one or more of the above with any other electronic device.

17. The device of claim 5 in which the alert device is adapted to notify the user of the existence of a detected battery charger only upon the existence of further predetermined conditions.

18. The device of claim 17 in which the further predetermined conditions comprise detecting the presence of the charger for an extended period of time.

19. A battery charger (20, 30) for a portable electronic device (10, 50), comprising:
charging means (23, 33) for providing power for recharging a battery (11); and
means (22, 32, 42) for transmitting compatibility data, over a wireless communication link (14, 15), to a remotely located portable electronic device.

20. The battery charger of claim 19 further including means (22, 32, 23, 33) for receiving compatibility data from the portable electronic device.

21. The device of claim 19 in which the means for transmitting compatibility data comprises a short range wireless device (22, 32).

22. The device of claim 20 in which the means for receiving compatibility data comprises a short range wireless device (22, 32).

23. The device of claim 21 in which the short range wireless device (22, 32) comprises one of a Bluetooth module, an IEEE 802.11 module, or an infra red module, adapted to communicate with an active wireless device in the portable electronic device.

24. The device of claim 20 further including an alert device for alerting the user of the portable electronic device of the existence of the detected compatible portable electronic device.

25. The device of claim 20 in which the alert device is inhibited when the charge level of the battery of the portable electronic device is greater than a predetermined amount.

26. The device of claim 19 in which the means (22, 32) for transmitting compatibility data operates intermittently.

27. The device of claim 19 in which the compatibility data includes a predetermined code sequence indicating compatibility between the charger and the portable electronic device.

28. The device of claim 19 in which the compatibility data includes one or more charge parameter including: battery capacity, battery chemistry, charging voltage and/or current, charging pattern, interconnection configuration, manufacturer, current status, charge time remaining to availability, charge tariff, charger location.

29. A method of automatically establishing the availability of a charging facility for a portable electronic device, comprising the steps of:
establishing a short range wireless communication link between a battery charger and a portable electronic device; and
transferring compatibility data over the wireless communication link from the charger to the portable electronic device to determine a compatibility between the battery charger and the portable electronic device.

30. The method of claim 29 in which the short range wireless communication link uses one of a Bluetooth protocol, an IEEE 802.11 protocol, or an infra red protocol.

31. The method of claim 29 in which the compatibility data is transferred using an RFID transceiver in the portable electronic device, adapted to communicate with a passive wireless device in the charger.

32. The method of claim 29 further including the step of alerting the user of the portable electronic device of the existence of a detected compatible battery charger.

33. The method of claim 32 in which the step of alerting is by way of one or more of an audible output, a visual output, or a vibration output.

34. The method of claim 32 in which the step of alerting is inhibited when the charge level of the battery of the portable electronic device is greater than a predetermined amount.

35. The method of claim 29 in which the step of establishing a short range wireless communication link operates intermittently.

36. The method of claim 29 in which the step of establishing a short range wireless communication link is initiated by the battery charger.

37. The method of claim 29 in which the compatibility data includes a predetermined code sequence indicating compatibility between the charger and the portable electronic device.

38. The method of claim 29 further including the step of transferring compatibility data from the portable electronic device and the battery charger.

39. The method of claim 29 in which the compatibility data includes one or more charge parameter including: battery capacity, battery chemistry, charging voltage, charging pattern, interconnection configuration, manufacturer, current status, charge time remaining to availability, charge tariff, charger location.
